(19) United States
(12) Patent Application Publication
(10) Pub. No.: US 2024/0020094 A1
(43) Pub. Date: Jan. 18, 2024

(54) MULTIPLICATION-ACCUMULATION SYSTEM, MULTIPLICATION-ACCUMULATION METHOD, AND ELECTRONIC DEVICE

(71) Applicant: Glenfly Tech Co., Ltd., Shanghai (CN)

(72) Inventors: Yuqin YU, Shanghai (CN); Yaohui ZENG, Shanghai (CN); Renyu BIAN, Shanghai (CN); Huaisheng ZHANG, Shanghai (CN)

(21) Appl. No.: 18/222,101

(22) Filed: Jul. 14, 2023

(30) Foreign Application Priority Data
Jul. 15, 2022 (CN) 202210830964.3
Jul. 15, 2022 (CN) 202210832162.6

(51) Int. Cl. G06F 7/523

(52) U.S. Cl. CPC G06F 7/523

(57) ABSTRACT

Multiplication-accumulation method and apparatus, a processor, and a computer program product are provided. The method includes: when a logical operation unit performs single-precision floating-point number multiplication-accumulation operation, combining two half-precision multiplier-accumulators in each single-precision multiplication-accumulation unit to perform the multiplication-accumulation operation on to-be-processed single-precision floating-point numbers to obtain corresponding single-precision multiplication-accumulation results, a total of N multiplication-accumulation results being obtained; and when the logical operation unit performs half-precision floating-point number multiplication-accumulation operation, performing, by each half-precision multiplier-accumulator, the multiplication-accumulation operation on to-be-processed half-precision floating-point numbers to obtain corresponding half-precision multiplication-accumulation results, a total of 2N multiplication-accumulation results being obtained. Utilization of the multiplier-accumulators is improved.

### CROSS REFERENCE TO RELATED APPLICATIONS

This application claims priority under 35 U.S.C. § 119 to Chinese Patent Application No. 202210832162.6, filed on Jul. 15, 2022, entitled as “HIGH-PERFORMANCE MULTIPLIER-ACCUMULATOR, MULTIPLICATION-ACCUMULATION METHOD, AND ELECTRONIC DEVICE” and Chinese Patent Application No. 202210830964.3, filed on Jul. 15, 2022, entitled as “ASYMMETRIC MULTIPLIER-ACCUMULATOR, MULTIPLICATION-ACCUMULATION METHOD, AND ELECTRONIC DEVICE”, the entire contents of which are incorporated herein in their entireties.

### TECHNICAL FIELD

The present disclosure relates to the field of chip technologies, and in particular, to a multiplication-accumulation system, a multiplication-accumulation method, and an electronic device.

### BACKGROUND

In a logical operation unit of a microprocessor, a floating-point number multiplication-accumulation operation is generally realized by using a multiplier-accumulator. In general, a design solution of the multiplier-accumulators in the logical operation unit is to arrange n single-precision multiplier-accumulators and 2n half-precision multiplier-accumulators. When the logical operation unit performs single-precision floating-point number multiplication-accumulation operations, the n single-precision multiplier-accumulators simultaneously operate to obtain n single-precision multiplication-accumulation results. When the logical operation unit performs half-precision floating-point number multiplication-accumulation operations, the 2n half-precision multiplier-accumulators simultaneously operate to obtain 2n half-precision multiplication-accumulation results.

However, when the logical operation unit performs single-precision floating-point number multiplication-accumulation operations, the 2n half-precision multiplier-accumulators are idle, and when the logical operation unit performs half-precision floating-point number multiplication-accumulation operations, the n single-precision multiplier-accumulators are idle, leading to low utilization rate of the multiplier-accumulators, and increased hardware overhead caused by the design of a large number of multiplier-accumulators.

### SUMMARY

Based on the above, there is a need to arrange, with respect to the above technical problems, a high-performance multiplier-accumulator, a multiplication-accumulation method, and an electronic device that can improve utilization of the multiplier-accumulator.

In a first aspect, the present disclosure provides a high-performance multiplier-accumulator, the high-performance multiplier-accumulator including: N single-precision multiplication-accumulation units, each of the single-precision multiplication-accumulation units including: two half-precision multiplier-accumulators;
when the high-performance multiplier-accumulator performs single-precision floating-point number multiplication-accumulation operations, the two half-precision multiplier-accumulators in each single-precision multiplication-accumulation unit are configured to be combined to perform the multiplication-accumulation operation on to-be-processed single-precision floating-point numbers to obtain a corresponding single-precision multiplication-accumulation result, a total of N multiplication-accumulation results being obtained; and
when the high-performance multiplier-accumulator performs half-precision floating-point number multiplication-accumulation operations, each half-precision multiplier-accumulator is configured to perform the multiplication-accumulation operation on to-be-processed half-precision floating-point numbers to obtain a corresponding half-precision multiplication-accumulation result, a total of 2N multiplication-accumulation results being obtained.

In a second aspect, the present disclosure further provides a multiplication-accumulation method, the method including:
when a high-performance multiplier-accumulator performs single-precision floating-point number multiplication-accumulation operations, combining two half-precision multiplier-accumulators in each single-precision multiplication-accumulation unit to perform the multiplication-accumulation operation on to-be-processed single-precision floating-point numbers to obtain a corresponding single-precision multiplication-accumulation result, a total of N multiplication-accumulation results being obtained; and
when the high-performance multiplier-accumulator performs half-precision floating-point number multiplication-accumulation operations, performing, by each half-precision multiplier-accumulator, the multiplication-accumulation operation on to-be-processed half-precision floating-point numbers to obtain a corresponding half-precision multiplication-accumulation result, a total of 2N multiplication-accumulation results being obtained.

In a third aspect, the present disclosure further provides an asymmetric multiplier-accumulator, the asymmetric multiplier-accumulator including: N multiplication-accumulation units, each of the multiplication-accumulation units including: a single-precision multiplier-accumulator and a half-precision multiplier-accumulator;
when the asymmetric multiplier-accumulator performs half-precision floating-point number multiplication-accumulation operations, the single-precision multiplier-accumulator and the half-precision multiplier-accumulator perform the multiplication-accumulation operations on to-be-processed half-precision floating-point numbers respectively to obtain corresponding half-precision multiplication-accumulation results, a total of 2N half-precision multiplication-accumulation results being obtained; and
when the asymmetric multiplier-accumulator performs single-precision floating-point number multiplication-accumulation operations, the single-precision multiplier-accumulator performs the multiplication-accumulation operation on to-be-processed single-precision floating-point numbers to obtain a corresponding single-precision multiplication-accumulation result, a total of N single-precision multiplication-accumulation results being obtained.

In a fourth aspect, the present disclosure further provides a multiplication-accumulation method, the method including:
when an asymmetric multiplier-accumulator performs half-precision floating-point number multiplication-accumulation operations, performing, by a single-precision multiplier-accumulator and a half-precision multiplier-accumulator, the multiplication-accumulation operations on to-be-processed half-precision floating-point numbers respectively to obtain corresponding half-precision multiplication-accumulation results, a total of 2N half-precision multiplication-accumulation results being obtained; and
when the asymmetric multiplier-accumulator performs single-precision floating-point number multiplication-accumulation operations, performing, by the single-precision multiplier-accumulator, the multiplication-accumulation operation on to-be-processed single-precision floating-point numbers to obtain a corresponding single-precision multiplication-accumulation result, a total of N single-precision multiplication-accumulation results being obtained.

In a fifth aspect, the present disclosure further provides an electronic device. The electronic device includes a memory and a processor. The memory stores a computer program, and the processor implements the method provided in the second aspect or the method provided in the fourth aspect when executing the computer program.

In a sixth aspect, the present disclosure further provides a computer-readable storage medium. The computer-readable storage medium stores a computer program, and the method provided in the second aspect or the method provided in the fourth aspect is implemented when the computer program is executed by a processor.

In a seventh aspect, the present disclosure further provides a computer program product. The computer program product includes a computer program, and the method provided in the second aspect or the method provided in the fourth aspect is implemented when the computer program is executed by a processor.

Two design ideas are provided in the above multiplication-accumulation method and apparatus, processor, and computer program product. One design idea is to still arrange 2n half-precision multiplier-accumulators in the logical operation unit. The 2n half-precision multiplier-accumulators are grouped in pairs to obtain a total of n groups. When the single-precision floating-point number multiplication-accumulation operations are performed, the half-precision multiplier-accumulators also participate in the operations and are not idle, improving utilization of the half-precision multiplier-accumulators. Moreover, according to the solution of the present disclosure, n single-precision multiplier-accumulators are saved, and the hardware overhead is reduced. Another design idea is to arrange n half-precision multiplier-accumulators and n single-precision multiplier-accumulators in the logical operation unit. One half-precision multiplier-adder and one single-precision multiplier-accumulator form a group, and a total of n groups are obtained. When the half-precision floating-point number multiplication-accumulation operations are performed, the single-precision multiplier-accumulators also participate in the operations and are not idle, improving utilization of the single-precision multiplier-accumulators. Moreover, the solution of the present disclosure saves n half-precision multiplier-accumulators and reduces the hardware overhead.

### BRIEF DESCRIPTION OF THE DRAWINGS

FIG. 1 is a schematic diagram of a data format of a single-precision floating-point number according to an embodiment;

FIG. 2 is a schematic diagram of a data format of a half-precision floating-point number according to an embodiment;

FIG. 3 is a schematic diagram of a logical operation unit design structure according to an embodiment;

FIG. 4 is a schematic diagram of a logical operation unit design structure according to another embodiment;

FIG. 5 is a schematic diagram of a logical operation unit design structure according to still another embodiment;

FIG. 6 is a schematic flow chart of a multiplication-accumulation method according to an embodiment;

FIG. 7 is a schematic diagram of internal structures of multiplier-accumulators according to an embodiment;

FIG. 8 is a schematic flow chart of a multiplication-accumulation operation for single-precision floating-point numbers according to an embodiment;

FIG. 9 is a schematic diagram of internal structures of multiplier-accumulators according to another embodiment;

FIG. 10 is a schematic flow chart of a multiplication-accumulation operation for half-precision floating-point numbers according to an embodiment;

FIG. 11 is a schematic flow chart of a multiplication-accumulation method according to another embodiment;

FIG. 12 is a schematic diagram of internal structures of multiplier-accumulators according to another embodiment;

FIG. 13 is a schematic flow chart of a multiplication-accumulation operation for half-precision floating-point numbers according to another embodiment;

FIG. 14 is a schematic diagram of internal structures of multiplier-accumulators according to another embodiment; and

FIG. 15 is a schematic flow chart of a multiplication-accumulation operation for single-precision floating-point numbers according to another embodiment.

### DETAILED DESCRIPTION OF THE EMBODIMENTS

In order to make the objectives, technical solutions, and advantages of the present disclosure clearer, the present disclosure is further described in detail below in conjunction with the accompanying drawings and embodiments. It should be understood that specific embodiments described herein are only intended to explain the present disclosure, and are not intended to limit the present disclosure.

For ease of understanding, terms involved in the embodiments of the present disclosure are explained as follows.

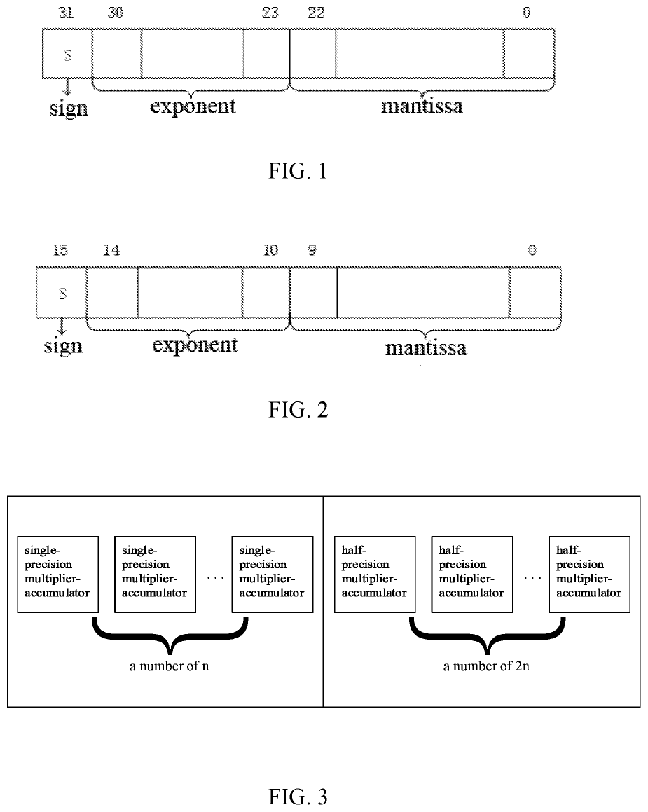

Single-precision floating-point number: It is stipulated in a binary floating-point arithmetic standard (Institute of Electrical and Electronics Engineers 754) that a single-precision floating-point number includes 32-bit binary data. A data format of the single-precision floating-point number is shown in FIG. 1.

S denotes a sign bit, S=0 means that a value represented by the single-precision floating-point number is positive, and S=1 means that the value represented by the single-precision floating-point number is negative.

Exponent denotes an exponent part, which is 8-bit binary data.

Mantissa denotes a part after a decimal point, which is 23-bit binary data.

Normal means that the exponent is not all 1 and not all 0, and the number 1 before the decimal point is omitted.

Denormal means that the exponent is all 0, the mantissa is not all 0, and the number 0 before the decimal point is omitted.

Exponent bias: A bias of a normal single-precision floating-point number is 0x7F, and a bias of a denormal single-precision floating-point number is 0x7E.

A value represented by the normal single-precision floating-point number is:

data=(−1)^{S}*2^{exponent-0x7F}*(1.mantissa)

A value represented by the denormal single-precision floating-point number is:

data=(−1)^{S}*2^{exponent-0x7F}*(0.mantissa)

Half-precision floating-point number: A half-precision floating-point number is formed by 16-bit binary data. A data format of the half-precision floating-point number is shown in FIG. 2.

S denotes a sign bit, S=0 means that a value represented by the half-precision floating-point number is positive, and S=1 means that the value represented by the half-precision floating-point number is negative.

Exponent denotes an exponent part, which is 5-bit binary data.

Mantissa denotes a part after a decimal point, which is 10-bit binary data.

Normal means that the exponent is not all 1 and not all 0, and the number 1 before the decimal point is omitted.

Denormal means that the exponent is all 0, the mantissa is not all 0, and the number 0 before the decimal point is omitted.

Exponent bias: A bias of a normal half-precision floating-point number is 0xF, and a bias of a denormal half-precision floating-point number is 0xE.

A value represented by the normal half-precision floating-point number is:

data=(−1)^{S}*2^{exponent-0x7F}*(1.mantissa)

A value represented by the denormal half-precision floating-point number is:

data=(−1)^{S}*2^{exponent-0x7F}*(0.mantissa)

In a logical operation unit of a microprocessor, a multiplication-accumulation operation for floating-point numbers is generally realized by using a multiplier-accumulator. According to some embodiments, references may be made to FIG. 3, in which a design solution of the multiplier-accumulator in the logical operation unit is to arrange n single-precision multiplier-accumulators and 2n half-precision multiplier-accumulators. When the logical operation unit performs a single-precision floating-point number multiplication-accumulation operation, the n single-precision multiplier-accumulators simultaneously operate to obtain n single-precision multiplication-accumulation results. When the logical operation unit perform a half-precision floating-point number multiplication-accumulation operations, the 2n half-precision multiplier-accumulators simultaneously operate to obtain 2n half-precision multiplication-accumulation results. In this manner, a problem is presented as follows. When the logical operation unit performs the single-precision floating-point number multiplication-accumulation operations, the 2n half-precision multiplier-accumulators are idle, and when the logical operation unit performs the half-precision floating-point number multiplication-accumulation operations, the n single-precision multiplier-accumulators are idle, leading to low utilization rate of the multiplier-accumulators, and increased hardware overhead caused by the design of a large number of multiplier-accumulators.

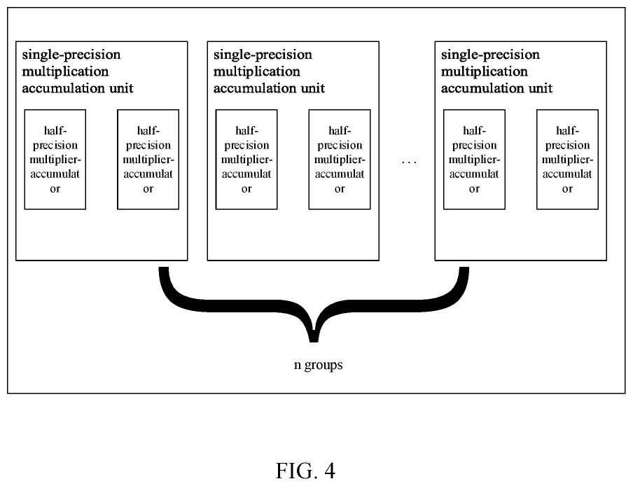

In view the above problem, two other design solutions are presented in some embodiments of the present disclosure. One design solution is, as shown in FIG. 4, to arrange a high-performance multiplier-accumulator, while arrange 2n half-precision multiplier-accumulators in the high-performance multiplier-accumulator. The 2n half-precision multiplier-accumulators are grouped in pairs to obtain a total of n groups. When the high-performance multiplier-accumulator performs a single-precision floating-point number multiplication-accumulation operation, two half-precision multiplier-accumulators in respective single-precision multiplication-accumulation unit are combined to perform the multiplication-accumulation operation on to-be-processed single-precision floating-point numbers to obtain corresponding single-precision multiplication-accumulation results, and a total of N single-precision multiplication-accumulation results may be obtained. For ease of description, in the embodiments of the present disclosure, each group is called a single-precision multiplication-accumulation unit. When the high-performance multiplier-accumulator performs a half-precision floating-point number multiplication-accumulation operation, the 2n half-precision multiplier-accumulators operate independently. That is, each half-precision multiplier-accumulator performs the multiplication-accumulation operation on to-be-processed half-precision floating-point numbers to obtain a corresponding half-precision multiplication-accumulation result. A total of 2N half-precision multiplication-accumulation results may be obtained. According to the solution in the embodiments of the present disclosure, when the single-precision floating-point number multiplication-accumulation operations are performed, the half-precision multiplier-accumulators also participate in the operations and are not idle, thereby improving utilization rate of the half-precision multiplier-accumulators. Moreover, compared with the design solution shown in FIG. 3, the solution in the embodiments of the present disclosure saves n single-precision multiplier-accumulators and reduces hardware overhead.

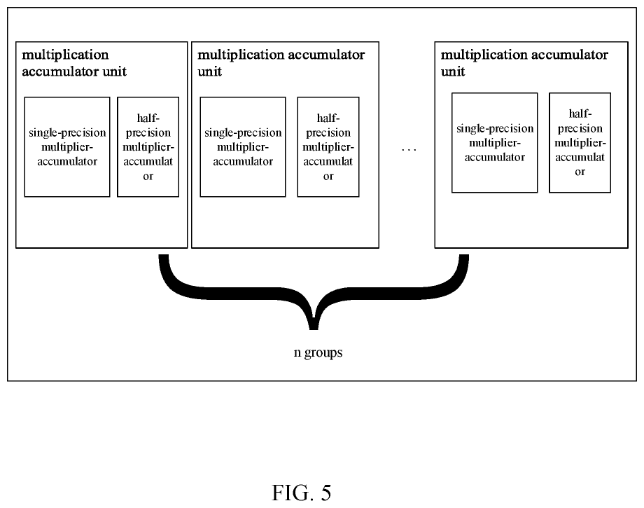

As shown in FIG. 5, the other design solution is, to arrange an asymmetric multiplier-accumulator and arrange n half-precision multiplier-accumulators and n single-precision multiplier-accumulators in the asymmetric multiplier-accumulator. One half-precision multiplier-accumulator and one single-precision multiplier-accumulator form a group, and a total of n groups are obtained. For ease of description, in the embodiments of the present disclosure, each group is called a multiplication-accumulation unit. When the asymmetric multiplier-accumulator performs single-precision floating-point number multiplication-accumulation operations, the n single-precision multiplier-accumulators operate independently. That is, each single-precision multiplier-accumulator performs the multiplication-accumulation operation on to-be-processed single-precision floating-point numbers to obtain a corresponding single-precision multiplication-accumulation result. A total of N single-precision multiplication-accumulation results may be obtained. When the asymmetric multiplier-accumulator performs half-precision floating-point number multiplication-accumulation operations, the n half-precision multiplier-accumulators operate independently, and n half-precision multiplication-accumulation results are obtained. However, if each single-precision multiplier-accumulator converts the to-be-processed half-precision floating-point numbers into single-precision floating-point numbers, then a multiplication-accumulation operation is performed, and a result is finally converted into half precision, such that n half-precision multiplication-accumulation results may also be obtained, and a total of 2n half-precision multiplication-accumulation results may be obtained. According to the solution in the embodiments of the present disclosure, when half-precision floating-point number multiplication-accumulation operations are performed, the single-precision multiplier-accumulators also participate in the operations and are not idle, thereby improving utilization rate of the single-precision multiplier-accumulators. Moreover, by comparing with the design solution shown in FIG. 3, the solution in the embodiments of the present disclosure saves n half-precision multiplier-accumulators and reduces the hardware overhead.

It is to be noted that the high-performance multiplier-accumulator shown in FIG. 4 is applicable to any types of processors that require floating-point multiplication-accumulation operations, and the asymmetric multiplier-accumulator shown in FIG. 5 is also applicable to any type of processors that require the floating-point multiplication-accumulation operations. The type of the processor is not limited in the embodiments of the present disclosure.

The high-performance multiplier-accumulator shown in FIG. 4 and the asymmetric multiplier-accumulator shown in FIG. 5 are respectively described in detail as follows.

Firstly, the high-performance multiplier-accumulator shown in FIG. 4 is described in detail.

According to an embodiment, the high-performance multiplier-accumulator includes: N single-precision multiplication-accumulation units. Each single-precision multiplication-accumulation unit includes: two half-precision multiplier-accumulators. When the high-performance multiplier-accumulator performs a single-precision floating-point number multiplication-accumulation operation, the two half-precision multiplier-accumulators in each single-precision multiplication-accumulation unit are configured to be combined to perform a multiplication-accumulation operation on to-be-processed single-precision floating-point numbers to obtain a corresponding single-precision multiplication-accumulation result, and a total of N multiplication-accumulation results are obtained. When the high-performance multiplier-accumulator performs half-precision floating-point number multiplication-accumulation operations, each half-precision multiplier-accumulator is configured to perform the multiplication-accumulation operations on to-be-processed half-precision floating-point numbers to obtain a corresponding half-precision multiplication-accumulation result, and a total of 2N multiplication-accumulation results are obtained.

The two half-precision multiplier-accumulators includes: a first half-precision multiplier-accumulator and a second half-precision multiplier-accumulator, and the to-be-processed single-precision floating-point numbers include: a first single-precision multiplier, a second single-precision multiplier, and a single-precision addend.

When the high-performance multiplier-accumulator performs the single-precision floating-point number multiplication-accumulation operation, the first half-precision multiplier-accumulator is specifically configured to perform a first-part multiplication to obtain a first multiplication result, and transmit the first multiplication result to the second half-precision multiplier-accumulator. The second half-precision multiplier-accumulator is specifically configured to perform a second-part multiplication to obtain a second multiplication result. The first-part multiplication and the second-part multiplication are classified based on a decimal of the first single-precision multiplier and a decimal of the second single-precision multiplier according to a preset rule. The second half-precision multiplier-accumulator is further configured to determine a decimal of a multiplication result according to the first multiplication result and the second multiplication result. The single-precision multiplication-accumulation result is determined according to the decimal of the multiplication result, an exponent of the first single-precision multiplier, an exponent of the second single-precision multiplier, a sign of the first single-precision multiplier, a sign of the second single-precision multiplier, a decimal of the single-precision addend, an exponent of the single-precision addend, and a sign of the single-precision addend.

The second half-precision multiplier-accumulator includes: an exponent addition module, a decimal addition module, and a determination module. The exponent addition module is configured to determine an exponent of the multiplication result according to the exponent of the first single-precision multiplier and the exponent of the second single-precision multiplier. The decimal addition module is configured to determine a sign of the multiplication result according to the sign of the first single-precision multiplier and the sign of the second single-precision multiplier. The determination module is configured to determine a decimal of a multiplication-accumulation result, a sign of the multiplication-accumulation result, and an exponent of the multiplication-accumulation result according to the exponent of the multiplication result, the exponent of the single-precision addend, the sign of the multiplication result, the sign of the single-precision addend, the decimal of the multiplication result, and the decimal of the single-precision addend; and determine the single-precision multiplication-accumulation result according to the decimal of the multiplication-accumulation result, the sign of the multiplication-accumulation result, and the exponent of the multiplication-accumulation result.

The determination module includes: a first exponent subtraction module, a first shift operation module, a first addition module, and a first multiplication-accumulation result exponent determination module. The first exponent subtraction module is configured to determine an absolute value of an exponent difference according to the exponent of the multiplication result and the exponent of the single-precision addend. The first shift operation module is configured to perform a shift operation on the decimal of the multiplication result or the decimal of the single-precision addend according to the exponent of the multiplication result, the exponent of the single-precision addend, and the absolute value of the exponent difference, to obtain a decimal of a multiplication result after the shift operation and a decimal of a single-precision addend after the shift operation. The first addition module is configured to determine the decimal of the multiplication-accumulation result and the sign of the multiplication-accumulation result according to the sign of the multiplication result, the sign of the single-precision addend, the decimal of the multiplication result after the shift operation, and the decimal of the single-precision addend after the shift operation. The first multiplication-accumulation result exponent determination module is configured to determine the exponent of the multiplication-accumulation result according to the exponent of the multiplication result and the exponent of the single-precision addend.

Specifically, the exponent addition module is specifically configured to:
determine the exponent of the multiplication result by using the following formula:

op01.exp=op0.exp+op1.exp−bias
where op01.exp denotes the exponent of the multiplication result, op0.exp denotes the exponent of the first single-precision multiplier, op1.exp denotes the exponent of the second single-precision multiplier, and bias denotes an exponent bias.

Specifically, the decimal addition module is specifically configured to:
perform an XOR operation on a sign of the first single-precision multiplier and a sign of the second single-precision multiplier to obtain a sign of the multiplication result.

Specifically, the first shift operation module is specifically configured to:
compare an exponent of the multiplication result and an exponent of a single-precision addend; right-shift a decimal of the single-precision addend by a number of digits corresponding to an absolute value if the exponent of the multiplication result is greater than or equal to the exponent of the single-precision addend; and right-shift the decimal of the multiplication result by the number of digits corresponding to the absolute value if the exponent of the multiplication result is less than the exponent of the single-precision addend.

Specifically, the first addition module is specifically configured to:
invert and add one to the decimal of the single-precision addend after the shift operation if the sign of the multiplication result is different from the sign of the single-precision addend, and obtain a decimal of a single-precision addend after the inversion and addition-by-one; and sum the decimal of the multiplication result after the shift operation and the decimal of the single-precision addend after the inversion and addition-by-one, and take the summing result as the decimal of the multiplication-accumulation result; and sum the decimal of the multiplication result after the shift operation and the decimal of the single-precision addend after the shift operation if the sign of the multiplication result is the same as the sign of the single-precision addend, and take the summing result as the decimal of the multiplication-accumulation result.

Specifically, the first multiplication-accumulation result exponent determination module is specifically configured to:
take the exponent of the multiplication result as the exponent of the multiplication-accumulation result if the exponent of the multiplication result is greater than or equal to the exponent of the single-precision addend; and take the exponent of the single-precision addend as the exponent of the multiplication-accumulation result if the exponent of the multiplication result is less than the exponent of the single-precision addend.

In an embodiment, the to-be-processed half-precision floating-point numbers include: a first half-precision multiplier, a second half-precision multiplier, and a half-precision addend.

When the high-performance multiplier-accumulator performs a half-precision floating-point number multiplication-accumulation operation, the half-precision multiplier-accumulator is specifically configured to determine a decimal of a multiplication result according to a decimal of the first half-precision multiplier and a decimal of the second half-precision multiplier; determine an exponent of the multiplication result according to an exponent of the first half-precision multiplier and an exponent of the second half-precision multiplier; determine a sign of the multiplication result according to a sign of the first half-precision multiplier and the sign of a second half-precision multiplier; determine a decimal of a multiplication-accumulation result, a sign of the multiplication-accumulation result, and an exponent of the multiplication-accumulation result according to the decimal of the multiplication result, the exponent of the multiplication result, the sign of the multiplication result, the exponent of the half-precision addend, the sign of the half-precision addend, and the decimal of the half-precision addend; and determine the half-precision multiplication-accumulation result according to the decimal of the multiplication-accumulation result, the sign of the multiplication-accumulation result, and the exponent of the multiplication-accumulation result.

The half-precision multiplier-accumulator includes: a second exponent subtraction module, a second shift operation module, a second addition module, and a second multiplication-accumulation result exponent determination module. The second exponent subtraction module is configured to determine an absolute value of an exponent difference according to the exponent of the multiplication result and the exponent of the half-precision addend. The second shift operation module is configured to perform a shift operation on the decimal of the multiplication result or the decimal of the half-precision addend according to the exponent of the multiplication result, the exponent of the half-precision addend, and the absolute value of the exponent difference, to obtain a decimal of a multiplication result after the shift operation and a decimal of a half-precision addend after the shift operation. The second addition module is configured to determine the decimal of the multiplication-accumulation result and the sign of the multiplication-accumulation result according to the sign of the multiplication result, the sign of the single-precision addend, the decimal of the multiplication result after the shift operation, and the decimal of the half-precision addend after the shift operation. The second multiplication-accumulation result exponent determination module is configured to determine the exponent of the multiplication-accumulation result according to the exponent of the multiplication result and the exponent of the single-precision addend.

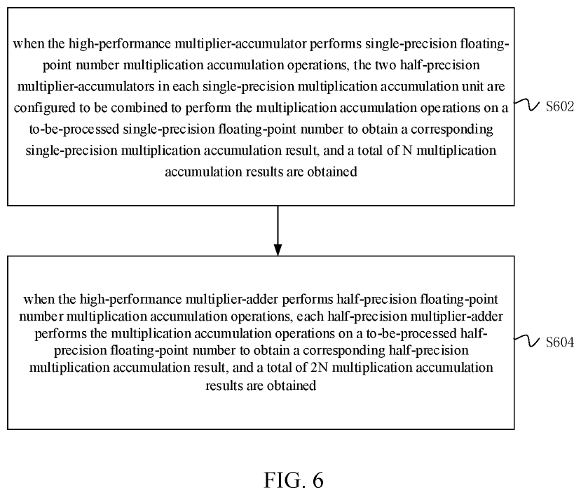

In an embodiment, as shown in FIG. 6, a multiplication-accumulation method is provided. The method is applied to the high-performance multiplier-accumulator shown in FIG. 4. The multiplication-accumulation method includes the following steps.

In S602, when the high-performance multiplier-accumulator performs single-precision floating-point number multiplication-accumulation operations, the two half-precision multiplier-accumulators in each single-precision multiplication-accumulation unit are configured to be combined to perform a multiplication-accumulation operation on to-be-processed single-precision floating-point numbers, and obtain a corresponding single-precision multiplication-accumulation result, and a total of N multiplication-accumulation results are obtained.

For ease of description, for each single-precision multiplication-accumulation unit, the two half-precision multiplier-accumulators included in the single-precision multiplication-accumulation unit may be referred to as a first half-precision multiplier-accumulator and a second half-precision multiplier-accumulator respectively. The multiplication-accumulation operation, as suggested by the name, includes both multiplication and addition. Therefore, the to-be-processed single-precision floating-point numbers include two single-precision multipliers and one single-precision addend. For ease of description, the two single-precision multipliers are referred to as a first single-precision multiplier and a second single-precision multiplier respectively.

An expression of the multiplication-accumulation operation is:

dst=op0*op1+op2
where op0 denotes the first single-precision multiplier, op1 denotes the second single-precision multiplier, op2 denotes the single-precision addend, and dst denotes a multiplication-accumulation result.

Variables used in a multiplication-accumulation process are described below.
op0.mant denotes a decimal of op0. op0.mant=1.mantissa when op0 is a normal single-precision floating-point number, and op0.mant=0.mantissa when op0 is a denormal single-precision floating-point number.
op1.mant denotes a decimal of op1. op1.mant=1.mantissa when op1 is the normal single-precision floating-point number, and op1.mant=0.mantissa when op1 is the denormal single-precision floating-point number.
op2.mant denotes a decimal of op2. op2.mant=1.mantissa when op2 is the normal single-precision floating-point number, and op2.mant=0.mantissa when op2 is the denormal single-precision floating-point number.
op01.mant denotes a decimal of a multiplication result of op0*op1.
dst.mant denotes a decimal of dst.
op0.exp denotes an exponent of op0.
op1.exp denotes an exponent of op1.
op2.exp denotes an exponent of op2.
op01.exp denotes an exponent of a multiplication result of op0*op1, and op01.exp=op0.exp+op1.exp-bias.
dst.exp denotes an exponent of dst.
op0.S denotes a sign of op0.
op1.S denotes a sign of op1.
op2.S denotes a sign of op2.
   op0.S denotes a sign of a multiplication result of op0*op1, and an XOR operation is performed on op0.S and op1.S to obtain op01.S.
   dst.S denotes a sign of dst.

Optionally, when a multiplication-accumulation operation is performed on the to-be-processed single-precision floating-point number, op0.mant*op1.mant may be divided into two parts based on op0.mant and op1.mant according to a preset rule. For ease of description, the two-part multiplication-accumulation operation obtained by division may be referred to as a first-part multiplication and a second-part multiplication.

For example, since

op0.mant[23:0]*op1.mant[23:0]=op0.mant[23:0]*op1.mant[11:0]+op0.mant[23:0]*op1.mant[23:12]

op0.mant[23:0]*op1.mant[23:0] may be divided into two parts of multiplication. The first-part multiplication is op0.mant[23:0]*op1.mant[11:0], and the second-part multiplication is op0.mant[23:0]*op1.mant[23:12]. Alternatively, the first-part multiplication is op0.mant[23:0]*op1.mant[23:12], and the second-part multiplication is op0.mant[23:0]*op1.mant[11:0].

It is to be noted that the above-mentioned manner of dividing the multiplication is merely an example, the embodiments of the present disclosure are not limited thereto, and other division manners may be feasible. For example, op0.mant[23:0]*op1.mant[23:0] is divided into op0.mant[23:0]*op1.mant[12:0] and op0.mant[23:0]*op1.mant[23:13].

Optionally, the first half-precision multiplier-accumulator may perform first-part multiplication to obtain a first multiplication result, and transmit the first multiplication result to the second half-precision multiplier-accumulator. The second half-precision multiplier-accumulator may perform the second-part multiplication to obtain a second multiplication result. The second half-precision multiplier-accumulator determines op01.mant according to the first multiplication result and the second multiplication result. Specifically, the second half-precision multiplier-accumulator may add the first multiplication result and the second multiplication result to obtain op01.mant. In the embodiments of the present disclosure, when a single-precision floating-point number multiplication-accumulation operation is performed, the multiplication is divided into two parts, the two half-precision multiplier-accumulators perform one part respectively, and then an addition is performed, so that the two half-precision multiplier-accumulators can perform the single-precision floating-point number multiplication-accumulation operation, thereby improving a utilization rate of the half-precision multiplier-accumulators, and reducing the hardware overhead because no additional single-precision multiplier-accumulator is required.

Optionally, after the two half-precision multiplier-accumulators operate together to obtain op01.mant, the second half-precision multiplier-accumulator may determine the corresponding single-precision multiplication-accumulation result according to op01.mant, op0.exp, op1.exp, op0.S, op1.S, op2.mant, op2.exp, and op2.S. Specifically, the second half-precision multiplier-accumulator may determine op01.exp according to op0.exp and op1.exp; determine op01.S according to op0.S and op1.S; determine dst.mant, dst.S, and dst.exp according to op01.exp, op2.exp, op01.S, op2.S, op01.mant, and op2.mant; and then normalize dst.mant, dst.S, and dst.exp to a data format of the single-precision floating-point number, so as to obtain the single-precision multiplication-accumulation result.

Optionally, two operands of the addition operation are op01 and op2. In order to make exponents of these two numbers the same, decimals are required to be shifted. The second half-precision multiplier-accumulator may determine an absolute value of an exponent difference according to op01.exp and op2.exp; and perform a shift operation on op01.mant or op2.mant according to op01.exp, op2.exp, and the absolute value of the exponent difference, to obtain op01.mant after the shift operation and op2.mant after the shift operation. The second half-precision multiplier-accumulator may determine dst.mant and dst.S according to op01.S, op2.S, op01.mant after the shift operation, and op2.mant after the shift operation; and determine dst.exp according to op01.exp and op2.exp.

Structures of the first half-precision multiplier-accumulator and the second half-precision multiplier-accumulator are described below.

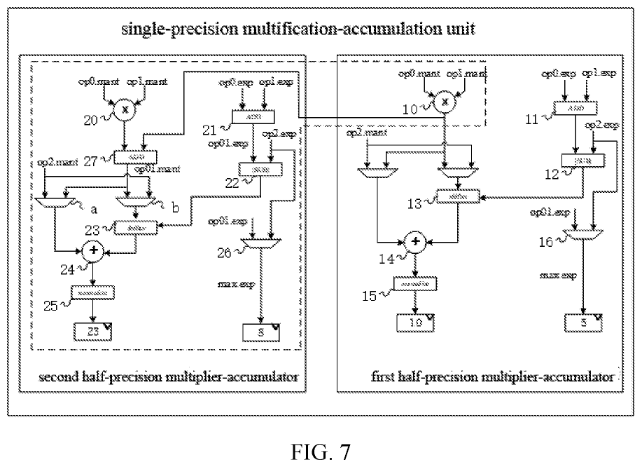

According to a possible implementation, the first half-precision multiplier-accumulator and the second half-precision multiplier-accumulator may be designed according to structures shown in FIG. 7. As shown in FIG. 7, the first half-precision multiplier-accumulator includes: a decimal multiplication operation module 10, an exponent addition operation module 11, an exponent subtraction operation module 12, a shift operation module 13, an addition module 14, a normalization module 15, and a multiplication-accumulation result exponent determination module 16. Similarly, the second half-precision multiplier-accumulator includes: a decimal multiplication operation module 20, an exponent addition operation module 21, an exponent subtraction operation module 22, a shift operation module 23, an addition operation module 24, a normalization module 25, and a multiplication-accumulation result exponent determination module 26. It is to be noted that, compared with the first half-precision multiplier-accumulator, the second half-precision multiplier-accumulator further includes: a decimal addition module 27. The decimal addition module 27 is connected to the decimal multiplication module 10 in the first half-precision multiplier-accumulator. The decimal multiplication module 10 in the first half-precision multiplier-accumulator, after obtaining a multiplication result, transmits the multiplication result to the decimal addition module 27. The decimal addition module 27 is configured to add the multiplication result obtained by the first single-precision multiplier-accumulator and a multiplication result obtained by the second single-precision multiplier-accumulator to obtain op01.mant.

It is to be noted that, as shown by a dashed box in FIG. 7, when the high-performance multiplier-accumulator performs a single-precision floating-point number multiplication-accumulation operation, only the decimal multiplication module 10 in the first half-precision multiplier-accumulator participates in the operations, and other operations are all performed in the second half-precision multiplier-accumulator.

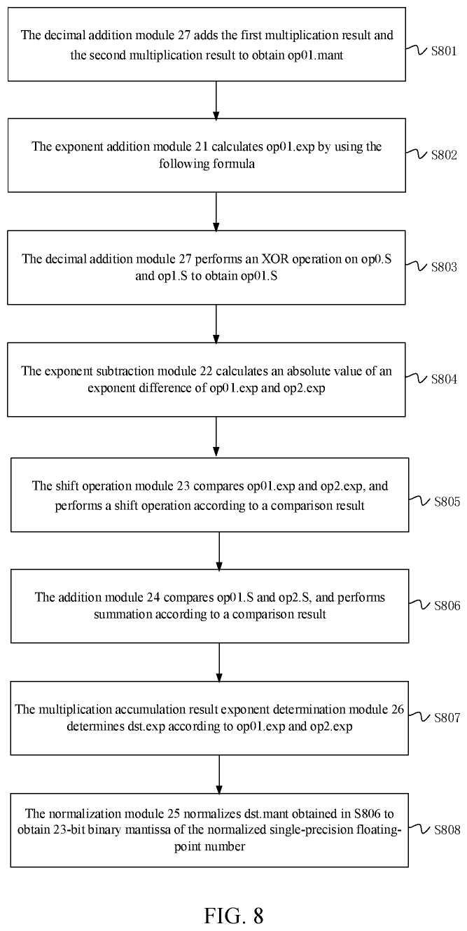

A process of the single-precision floating-point number multiplication-accumulation operation is described in detail below with reference to the structures shown in FIG. 7. As shown in FIG. 8, the process specifically includes the following steps.

In S801, the decimal multiplication module 10 performs a first-part multiplication to obtain a first multiplication result, and transmits the first multiplication result to the decimal addition module 27. The decimal multiplication module 20 performs second-part multiplication to obtain a second multiplication result, and transmits the second multiplication result to the decimal addition module 27. The decimal addition module 27 adds the first multiplication result and the second multiplication result to obtain op01.mant.

Specifically, the division manner of the multiplication may be obtained with reference to the above. Details are not described herein again in the embodiments of the present disclosure.

In S802, the exponent addition module 21 calculates op01.exp by using the following formula:

op01.exp=op0.exp+op1.exp−bias

where bias denotes a bias of a normal single-precision floating-point number, that is, bias=0x7F.

In S803, the decimal addition module 27 performs an XOR operation on op0.S and op1.S to obtain op01.S.

Optionally, op0.S and op1.S may be inputted to the decimal addition module 27, so that the decimal addition module 27 performs the XOR operation.

In S804, the exponent subtraction module 22 calculates an absolute value of an exponent difference of op01.exp and op2.exp.

Optionally, after calculating the absolute value of the exponent difference, the exponent subtraction module 22 may transmit op01.exp, op2.exp, and the absolute value to the shift operation module 23.

In S805, the shift operation module 23 compares op01.exp and op2.exp, and performs a shift operation according to a comparison result.

Specifically, if op01.exp is greater than or equal to op2.exp, op2.mant is right-shifted by a number of digits corresponding to the absolute value. If op01.exp is less than op2.exp, op01.mant is right-shifted by the number of digits corresponding to the absolute value, to obtain op01.mant and op2.mant after the shift operation.

Specifically, if op01.exp>=op2.exp, op2.mant is right-shifted by |op01.exp-op2.exp|.

If op01.exp<op2.exp, op01.mant is right-shifted by |op00.exp-op2.exp|.

Optionally, two selectors a and b may be provided between the decimal addition module 27 and the shift operation module 23. If the shift operation module 23 determines op01.exp>=op2.exp, op2.mant is selected from the selector b for a shift operation. In this case, the selector a transmits op01.mant to the addition module 24. If the shift operation module 23 determines op01.exp<op2.exp, op01.mant is selected from the selector b for a shift operation. In this case, the selector a transmits op2.mant to the addition module 24.

In S806, the addition module 24 compares op01.S and op2.S, and performs summation according to a comparison result.

If op01.S and op2.S are different, op2.mant after the shift operation in S805 is inverted and one is added thereto, to obtain op2.mant after the inversion and addition-by-one; and op2.mant after the inversion and addition-by-one and op01.mant after the shift operation in S806 are summed, and a sum result is taken as dst.mant. Moreover, dst.S is equal to op01.S.

If op01.S and op2.S are the same, op2.mant and op01.mant after the shift operation in S805 are directly summed, and a sum result is taken as dst.mant. Moreover, dst.S is equal to op01.S.

Optionally, the decimal addition module 27 may transmit op01.S to the addition module 24 through the shift operation module 23, and may input op2.S to the addition module 24, so that the addition module 24 can judge whether op01.S and op2.S are the same. Alternatively, op0.S, op1.S, and op2.S are all directly inputted to the addition module 24, so that the addition module 24 performs the XOR operation to obtain op01.S and performs the above judgment according to op01.S and op2.S.

In S807, the multiplication-accumulation result exponent determination module 26 determines dst.exp according to op01.exp and op2.exp.

Specifically, if op01.exp>=op2.exp, dst.exp=op01.exp.

If op01.exp<op2.exp, dst.exp=op02.exp.

Optionally, after dst.exp is obtained, dst.exp may be normalized to obtain an 8-bit binary exponent of the normalized single-precision floating-point number.

In S808, the normalization module 25 normalizes dst.mant obtained in S806 to obtain 23-bit binary mantissa of the normalized single-precision floating-point number.

Optionally, the addition module 24 may transmit dst.S to the normalization module 25. In this case, the normalization module 25 also outputs a sign bit in addition to the 23-bit binary mantissa. The sign bit, the 8-bit binary exponent obtained in S807, and the 23-bit binary mantissa obtained in S808 form the single-precision multiplication-accumulation result.

In the above multiplication-accumulation method, the multiplication is divided into two parts, and each of the two half-precision multiplier-accumulators performs one part respectively, so that the two half-precision multiplier-accumulators are combined to complete the single-precision floating-point number multiplication-accumulation operation, which improves utilization of the half-precision multiplier-accumulators, requires no additional single-precision multiplier-accumulators, and reduces the hardware overhead.

In S604, when the high-performance multiplier-accumulator performs half-precision floating-point number multiplication-accumulation operations, each half-precision multiplier-accumulator performs the multiplication-accumulation operation on to-be-processed half-precision floating-point numbers to obtain a corresponding half-precision multiplication-accumulation result, and a total of 2N multiplication-accumulation results are obtained.

The to-be-processed half-precision floating-point numbers include two half-precision multipliers and one half-precision addend. For ease of description, the two half-precision multipliers are called a first half-precision multiplier and a second half-precision multiplier respectively.

An expression of the multiplication-accumulation operations is:

dst=op0*op1+op2

where op0 denotes the first half-precision multiplier, op1 denotes the second half-precision multiplier, op2 denotes the half-precision addend, and dst denotes a multiplication-accumulation result.

It is to be noted that, different from the single-precision floating-point number multiplication-accumulation process, since a single half-precision multiplier-accumulator supports the half-precision floating-point number multiplication-accumulation operation, there is no need to divide the multiplication.

Optionally, the half-precision multiplier-accumulator may determine op01.mant according to op1.mant and op2.mant; determine op01.exp according to op0.exp and op1.exp; determine op01.S according to op0.S and op1.S; determine dst.mant, dst.exp, and dst.S according to op01.mant, op01.exp, op01.S, op2.mant, op2.exp, and op2.S; and then normalize dst.mant, dst.exp, and dst.S to a data format of the half-precision floating-point number, so as to obtain the half-precision multiplication-accumulation result.

Similarly, two operands of the addition are op01 and op2. In order to make exponents of these two numbers the same, decimals are required to be shifted. The half-precision multiplier-accumulator may determine an absolute value of an exponent difference according to op01.exp and op2.exp; perform a shift operation on op01.mant or op2.mant according to op01.exp, op2.exp, and the absolute value of the exponent difference, to obtain op01.mant after the shift operation and op2.mant after the shift operation; determine dst.mant and dst.S according to op01.S, op2.S, op01.mant after the shift operation, and op2.mant after the shift operation; and determine dst.exp according to op01.exp and op2.exp.

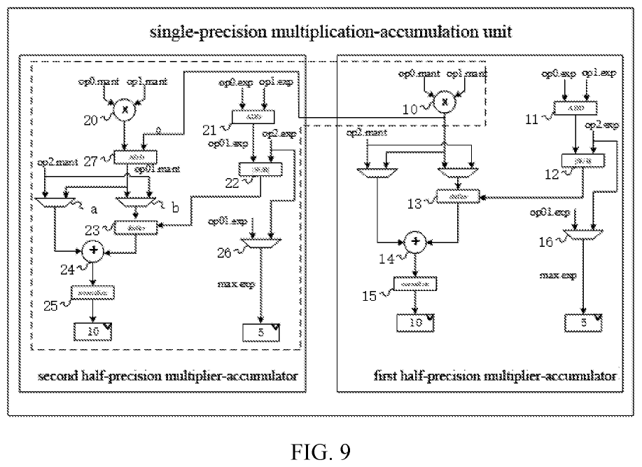

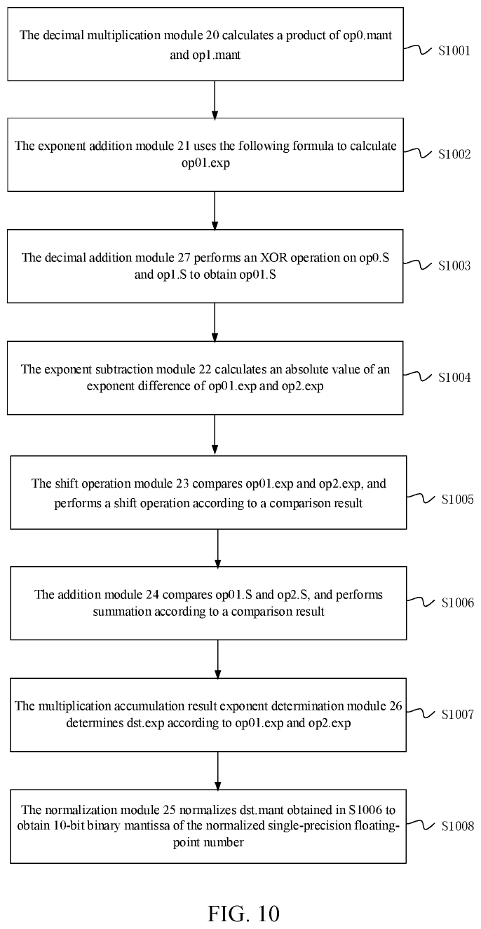

A process of the half-precision floating-point number multiplication-accumulation operations is described in detail below with reference to the structures shown in FIG. 9. Taking the second half-precision multiplier-accumulator as an example, as shown in FIG. 10, the process specifically includes the following steps.

In S1001, the decimal multiplication module 20 calculates a product of op0.mant and op1.mant.

Specifically, op1.mant and op2.mant are both 11-bit binary data, and the op01.mant obtained through calculation is 22-bit binary data. Since the decimal multiplication module 10 is connected to the decimal addition module 27 and each half-precision multiplier-accumulator performs the half-precision floating-point number multiplication-accumulation operation, that is, the first half-precision multiplier-accumulator also performs the half-precision floating-point number multiplication-accumulation operation, in order to prevent an influence of data transmitted from the decimal multiplication module 10, the decimal addition module 27 may zero the data transmitted from the decimal multiplication module 10. In this way, an output result of the decimal addition module 27 is a calculation result of the decimal multiplication module 20.

In 51002, the exponent addition module 21 calculates op01.exp.

In 51003, the decimal addition module 27 performs an XOR operation on op0.S and op1.S to obtain op01.S.

In 51004, the exponent subtraction module 22 calculates an absolute value of an exponent difference of op01.exp and op2.exp.

In 51005, the shift operation module 23 compares op01.exp and op2.exp, and performs a shift operation according to a comparison result.

In S1006, the addition module 24 compares op01.S and op2.S, and performs summation according to a comparison result to obtain dst.mant.

In S1007, the multiplication-accumulation result exponent determination module 26 determines dst.exp according to op01.exp and op2.exp.

After dst.exp is obtained, dst.exp may be normalized to obtain a 5-bit binary exponent of the normalized single-precision floating-point number.

In S1008, the normalization module 25 normalizes dst.mant obtained in S1006 to obtain 10-bit binary mantissa of the normalized single-precision floating-point number.

Implementation processes of S1001 to S1008 are similar to those of S801 to S808. Details are not described herein again in the embodiments of the present disclosure. The sign bit, the 5-bit binary exponent obtained in S1007, and the 10-bit binary mantissa obtained in S1008 form the half-precision multiplication-accumulation result.

According to the multiplication-accumulation method in the embodiments of the present disclosure, when the high-performance multiplier-accumulator performs single-precision floating-point number multiplication-accumulation operation, the two half-precision multiplier-accumulators in each single-precision multiplication-accumulation unit are combined to perform the multiplication-accumulation operation on to-be-processed single-precision floating-point numbers to obtain a corresponding single-precision multiplication-accumulation result, and a total of N multiplication-accumulation results are obtained. When the high-performance multiplier-accumulator performs half-precision floating-point number multiplication-accumulation operations, each half-precision multiplier-accumulator performs the multiplication-accumulation operation on to-be-processed half-precision floating-point numbers to obtain a corresponding half-precision multiplication-accumulation result, and a total of 2N multiplication-accumulation results are obtained. According to the solution in the embodiments of the present disclosure, when the single-precision floating-point number multiplication-accumulation operations are performed, the half-precision multiplier-accumulators also participate in the operations and are not idle, improving utilization of the half-precision multiplier-accumulators. Moreover, compared with the design solution shown in FIG. 3, the solution in the embodiments of the present disclosure saves n single-precision multiplier-accumulators and reduces the hardware overhead.

The asymmetric multiplier-accumulator shown in FIG. 5 is described in detail below.

In an embodiment, the asymmetric multiplier-accumulator includes: N multiplication-accumulation units. Each multiplication-accumulation unit includes: a single-precision multiplier-accumulator and a half-precision multiplier-accumulator. When the asymmetric multiplier-accumulator performs half-precision floating-point number multiplication-accumulation operations, the single-precision multiplier-accumulator and the half-precision multiplier-accumulator respectively perform multiplication-accumulation operations on to-be-processed half-precision floating-point numbers to obtain corresponding half-precision multiplication-accumulation results, and a total of 2N half-precision multiplication-accumulation results are obtained. When the asymmetric multiplier-accumulator performs single-precision floating-point number multiplication-accumulation operations, the single-precision multiplier-accumulator performs the multiplication-accumulation operation on to-be-processed single-precision floating-point numbers to obtain a corresponding single-precision multiplication-accumulation result, and a total of N single-precision multiplication-accumulation results are obtained.

The to-be-processed half-precision floating-point numbers include: a first half-precision multiplier, a second half-precision multiplier, and a half-precision addend. The single-precision multiplier-accumulator includes: a first conversion unit, a determination module, and a second conversion unit. The first conversion unit is configured to convert the first half-precision multiplier, the second half-precision multiplier, and the half-precision addend into single precision, to obtain a first single-precision multiplier, a second single-precision multiplier, and a single-precision addend. The determination module is configured to determine the single-precision multiplication-accumulation result according to a decimal of the first single-precision multiplier, an exponent of the first single-precision multiplier, a sign of the first single-precision multiplier, a decimal of the second single-precision multiplier, an exponent of the second single-precision multiplier, a sign of the second single-precision multiplier, a decimal of the single-precision addend, an exponent of the single-precision addend, and a sign of the single-precision addend. The second conversion unit is configured to convert the single-precision multiplication-accumulation result to obtain the half-precision multiplication-accumulation result.

The determination module includes: a decimal multiplication module, an exponent addition module, an addition module, and a determination unit. The decimal multiplication module is configured to determine a decimal of a multiplication result according to the decimal of the first single-precision multiplier and the decimal of the second single-precision multiplier. The exponent addition module is configured to determine an exponent of the multiplication result according to the exponent of the first single-precision multiplier and the exponent of the second single-precision multiplier. The addition module is configured to determine a sign of the multiplication result according to the sign of the first single-precision multiplier and the sign of the second single-precision multiplier. The determination unit is configured to determine a decimal of a multiplication-accumulation result, a sign of the multiplication-accumulation result, and an exponent of the multiplication-accumulation result according to the decimal of the multiplication result, the exponent of the multiplication result, the sign of the multiplication result, the exponent of the single-precision addend, the sign of the single-precision addend, and the decimal of the single-precision addend; and determine the single-precision multiplication-accumulation result according to the decimal of the multiplication-accumulation result, the sign of the multiplication-accumulation result, and the exponent of the multiplication-accumulation result.

The determination unit includes: a first exponent subtraction module, a first shift operation module, a first addition module, and a first multiplication-accumulation result exponent determination module. The first exponent subtraction module is configured to determine an exponent difference according to the exponent of the multiplication result and the exponent of the single-precision addend. The first shift operation module is configured to perform a shift operation on the decimal of the multiplication result or the decimal of the single-precision addend according to the exponent of the multiplication result, the exponent of the single-precision addend, and the exponent difference, to obtain a decimal of a multiplication result after the shift operation and a decimal of a single-precision addend after the shift operation. The first addition module is configured to determine the decimal of the multiplication-accumulation result and the sign of the multiplication-accumulation result according to the sign of the multiplication result, the sign of the single-precision addend, the decimal of the multiplication result after the shift operation, and the decimal of the single-precision addend after the shift operation. The first multiplication-accumulation result exponent determination module is configured to determine the exponent of the multiplication-accumulation result according to the exponent of the multiplication result and the exponent of the single-precision addend.

Specifically, the exponent addition module is specifically configured to:

determine the exponent of the multiplication result by using the following formula:

op01.exp=op0.exp+op1.exp−bias

where op01.exp denotes the exponent of the multiplication result, op0.exp denotes the exponent of the first single-precision multiplier, op1.exp denotes the exponent of the second single-precision multiplier, and bias denotes an exponent bias.

Specifically, the addition module is specifically configured to:
perform an XOR operation on the sign of the first single-precision multiplier and the sign of the second single-precision multiplier to obtain the sign of the multiplication result.

Specifically, the first shift operation module is specifically configured to:
compare the exponent of the multiplication result and the exponent of the single-precision addend; right-shift the decimal of the single-precision addend by a number of digits corresponding to the exponent difference if the exponent of the multiplication result is greater than or equal to the exponent of the single-precision addend; and right-shift the decimal of the multiplication result by the number of digits corresponding to the exponent difference if the exponent of the multiplication result is less than the exponent of the single-precision addend.

Specifically, the first addition module is specifically configured to: invert and add one to the decimal of the single-precision addend after the shift operation if the sign of the multiplication result is different from the sign of the single-precision addend, to obtain a decimal of a single-precision addend after the inversion and addition-by-one; and sum the decimal of the multiplication result after the shift operation and the decimal of the single-precision addend after the inversion and addition-by-one, and take a sum result as the decimal of the multiplication-accumulation result; and sum the decimal of the multiplication result after the shift operation and the decimal of the single-precision addend after the shift operation if the sign of the multiplication result is the same as the sign of the single-precision addend, and take a sum result as the decimal of the multiplication-accumulation result.

Specifically, the first multiplication-accumulation result exponent determination module is specifically configured to:
take the exponent of the multiplication result as the exponent of the multiplication-accumulation result if the exponent of the multiplication result is greater than or equal to the exponent of the single-precision addend; and take the exponent of the single-precision addend as the exponent of the multiplication-accumulation result if the exponent of the multiplication result is less than the exponent of the single-precision addend.

In an embodiment, the to-be-processed single-precision floating-point numbers include: a first single-precision multiplier, a second single-precision multiplier, and a single-precision addend. The single-precision multiplier-accumulator is specifically configured to determine a decimal of a multiplication result according to a decimal of the first single-precision multiplier and a decimal of the second single-precision multiplier; determine an exponent of the multiplication result according to an exponent of the first single-precision multiplier and an exponent of the second single-precision multiplier; determine a sign of the multiplication result according to a sign of the first single-precision multiplier and a sign of the second single-precision multiplier; determine a decimal of a multiplication-accumulation result, a sign of the multiplication-accumulation result, and an exponent of the multiplication-accumulation result according to the decimal of the multiplication result, the exponent of the multiplication result, the sign of the multiplication result, the exponent of the single-precision addend, the sign of the single-precision addend, and the decimal of the single-precision addend; and determine the single-precision multiplication-accumulation result according to the decimal of the multiplication-accumulation result, the sign of the multiplication-accumulation result, and the exponent of the multiplication-accumulation result.

The single-precision multiplier-accumulator includes: a second exponent subtraction module, a second shift operation module, a second addition module, and a second multiplication-accumulation result exponent determination module. The second exponent subtraction module is configured to determine an exponent difference according to the exponent of the multiplication result and the exponent of the single-precision addend. The second shift operation module is configured to perform a shift operation on the decimal of the multiplication result or the decimal of the single-precision addend according to the exponent of the multiplication result, the exponent of the single-precision addend, and the exponent difference, to obtain a decimal of a multiplication result after the shift operation and a decimal of a single-precision addend after the shift operation. The second addition module is configured to determine the decimal of the multiplication-accumulation result and the sign of the multiplication-accumulation result according to the sign of the multiplication result, the sign of the single-precision addend, the decimal of the multiplication result after the shift operation, and the decimal of the single-precision addend after the shift operation. The second multiplication-accumulation result exponent determination module is configured to determine the exponent of the multiplication-accumulation result according to the exponent of the multiplication result and the exponent of the single-precision addend.

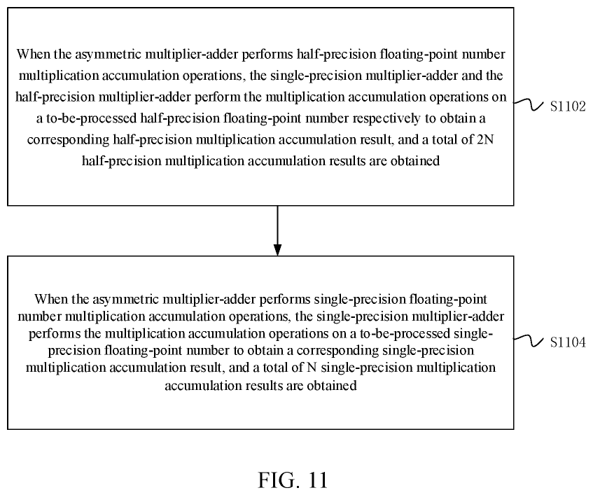

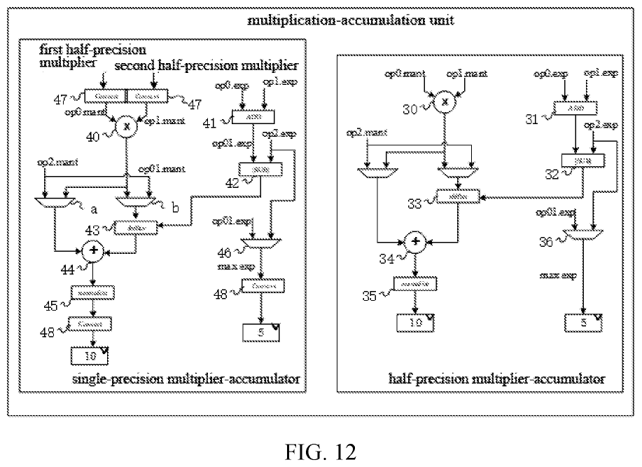

In an embodiment, as shown in FIG. 11, a multiplication-accumulation method is provided. The method is applied to the asymmetric multiplier-accumulator shown in FIG. 5. The multiplication-accumulation method includes the following steps.

In S1102, when the asymmetric multiplier-accumulator performs half-precision floating-point number multiplication-accumulation operations, the single-precision multiplier-accumulator and the half-precision multiplier-accumulator perform the multiplication-accumulation operations on to-be-processed half-precision floating-point numbers respectively to obtain corresponding half-precision multiplication-accumulation results, and a total of 2N half-precision multiplication-accumulation results are obtained.

It is to be noted that a process of the half-precision multiplier-accumulator performing the half-precision floating-point number multiplication-accumulation operations may be obtained with reference to the prior art. Details are not described herein again in the embodiments of the present disclosure. The following focuses on a process of the single-precision multiplier-accumulator performing the half-precision floating-point number multiplication-accumulation operations.

The to-be-processed half-precision floating-point numbers include: two half-precision multipliers and one half-precision addend. For ease of description, the two half-precision multipliers are called a first half-precision multiplier and a second half-precision multiplier respectively.

Optionally, the single-precision multiplier may convert the first half-precision multiplier, the second half-precision multiplier, and the half-precision addend into single precision, to obtain a first single-precision multiplier, a second single-precision multiplier, and a single-precision addend, and then perform the multiplication-accumulation operation on the first single-precision multiplier, the second single-precision multiplier, and the single-precision addend.

An expression of the multiplication-accumulation operations is:

dst=op0*op1+op2

where op0 denotes the first single-precision multiplier after the conversion, op1 denotes the second single-precision multiplier after the conversion, op2 denotes the single-precision addend after the conversion, and dst denotes a single-precision multiplication-accumulation result.

Optionally, after the above conversion, the single-precision multiplier-accumulator may determine the single-precision multiplication-accumulation result according to op0.mant, op1.mant, op2.mant, op0.exp, op1.exp, op2.exp, op0.S, op1.S, and op2.S; and convert the single-precision multiplication-accumulation result to obtain the half-precision multiplication-accumulation result. In this way, the single-precision multiplier-accumulator can also perform the half-precision floating-point number multiplication-accumulation operations, improving utilization of the single-precision multiplier-accumulator. According to the solution in the embodiments of the present disclosure, fewer n half-precision multiplier-accumulators can be provided, reducing the hardware overhead.

Optionally, a process of converting the half-precision floating-point number into a single-precision floating-point number may be obtained with reference to the prior art. Details are not described herein again in the embodiments of the present disclosure.

Optionally, the single-precision multiplier-accumulator may determine op01.mant according to op0.mant and op1.mant; determine op01.exp according to op0.exp and op2.exp; determine op01.S according to op0.S and op1.S; determine dst.mant, dst.S, and dst.exp according to op01.mant, op01.exp, op01.S, op2.exp, op2.S, and op2.mant; and then normalize dst.mant, dst.S, and dst.exp to a data format of the single-precision floating-point number, so as to obtain the single-precision multiplication-accumulation result.

Similarly, two operands of the addition are op01 and op2. In order to make exponents of these two numbers the same, decimals are required to be shifted. The half-precision multiplier-accumulator may determine an absolute value of an exponent difference according to op01.exp and op2.exp; perform a shift operation on op01.mant or op2.mant according to op01.exp, op2.exp, and the absolute value of the exponent difference, to obtain op01.mant after the shift operation and op2.mant after the shift operation; determine dst.mant and dst.S according to op01.S, op2.S, op01.mant after the shift operation, and op2.mant after the shift operation; and determine dst.exp according to op01.exp and op2.exp.

Structures of the single-precision multiplier-accumulator and the half-precision multiplier-accumulator are described below.

In a possible implementation, the single-precision multiplier-accumulator and the half-precision multiplier-accumulator may be designed to structures shown in FIG. 12. As shown in FIG. 12, the half-precision multiplier-accumulator includes: a decimal multiplication module 30, an exponent addition module 31, an exponent subtraction module 32, a shift operation module 33, an addition module 34, a normalization module 35, and a multiplication-accumulation result exponent determination module 36. The single-precision multiplier-accumulator includes: a decimal multiplication module 40, an exponent addition module 41, an exponent subtraction module 42, a shift operation module 43, an addition module 44, a normalization module 45, and a multiplication-accumulation result exponent determination module 46. It is to be noted that, compared with the half-precision multiplier-accumulator, the single-precision multiplier-accumulator further includes: a first conversion unit 47 and a second conversion unit 48. The single-precision multiplier-accumulator, when performing the half-precision floating-point number multiplication-accumulation operation, first converts, through the first conversion unit 47, the first half-precision multiplier, the second half-precision multiplier, and the half-precision addend into single precision to obtain op0, op1, and op2, then calculates dst=op0*op1+op2 to obtain a single-precision multiplication-accumulation result, and then converts the single-precision multiplication-accumulation result to obtain a half-precision multiplication-accumulation result.

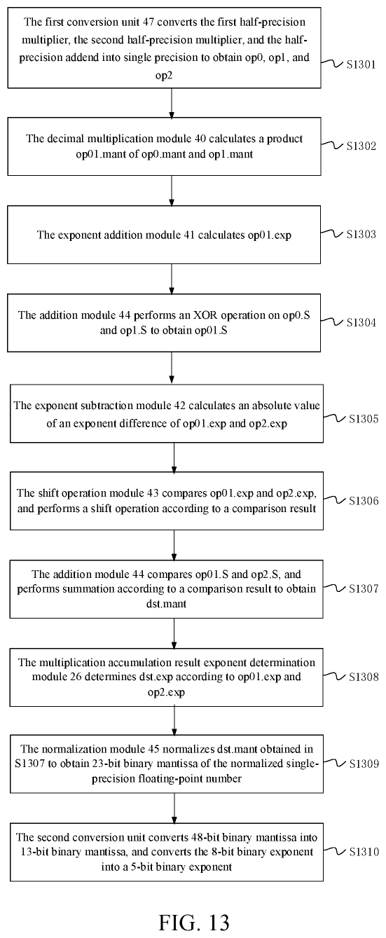

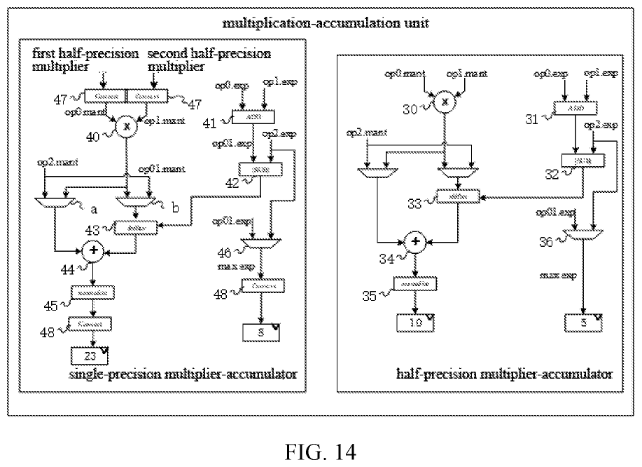

A process of the single-precision multiplier-accumulator performing the half-precision floating-point number multiplication-accumulation operations is described in detail below with reference to the structures shown in FIG. 12. As shown in FIG. 13, the process specifically includes the following steps.

In S1301, the first conversion unit 47 converts the first half-precision multiplier, the second half-precision multiplier, and the half-precision addend into single precision to obtain op0, op1, and op2.

Optionally, a process of converting the half-precision floating-point number into a single-precision floating-point number may be obtained with reference to the prior art. Details are not described herein again in the embodiments of the present disclosure. The first conversion unit 47, after obtaining op0, op1, and op2 by conversion, transmits op0.mant and op1.mant to the decimal multiplication module 40.

In S1302, the decimal multiplication module 40 calculates a product op01.mant of op0.mant and op1.mant.

Specifically, op0.mant and op1.mant are both 24-bit binary data, and the op01.mant obtained through calculation is 48-bit binary data.

In S1303, the exponent addition module 41 calculates op01.exp.

In S1304, the addition module 44 performs an XOR operation on op0.S and op1.S to obtain op01.S.

Optionally, op0.S, op1.S, and op2.S may be inputted to the addition module 44, so that the addition module 44 can perform the XOR operation to obtain op01. S.

In S1305, the exponent subtraction module 42 calculates an absolute value of an exponent difference of op01.exp and op2.exp.

In S1306, the shift operation module 43 compares op01.exp and op2.exp, and performs a shift operation according to a comparison result.

In S1307, the addition module 44 compares op01.S and op2.S, and performs summation according to a comparison result to obtain dst.mant.

In S1308, the multiplication-accumulation result exponent determination module 26 determines dst.exp according to op01.exp and op2.exp.

After dst.exp is obtained, dst.exp may be normalized to obtain an 8-bit binary exponent of the normalized single-precision floating-point number.

In S1309, the normalization module 45 normalizes dst.mant obtained in S1307 to obtain 23-bit binary mantissa of the normalized single-precision floating-point number.

In S1310, the second conversion unit converts 48-bit binary mantissa into 10-bit binary mantissa, and converts the 8-bit binary exponent into a 5-bit binary exponent.

Optionally, the addition module 44 may transmit dst.S to the normalization module 45. In this case, the normalization module 45 also outputs a sign bit in addition to the 23-bit binary mantissa. The sign bit, the 10-bit binary exponent obtained in S1310, and the 5-bit binary mantissa obtained in S1310 form the half-precision multiplication-accumulation result.

In the above multiplication-accumulation method, the half-precision floating-point number is converted into single precision. In this way, the single-precision multiplier-accumulator can also perform the half-precision floating-point number multiplication-accumulation operations, improving utilization of the single-precision multiplier-accumulator. According to the solution in the embodiments of the present disclosure, fewer n half-precision multiplier-accumulators can be provided, reducing the hardware overhead.

It is to be noted that, compared with the process shown in FIG. 13, the process of the half-precision multiplier-accumulator performing the half-precision floating-point number operations in FIG. 12 requires no conversion, so S1201 and S1210 are skipped, and other processes are similar. Details are not described herein again in the embodiments of the present disclosure.

In S1104, when the asymmetric multiplier-accumulator performs single-precision floating-point number multiplication-accumulation operations, the single-precision multiplier-accumulator performs the multiplication-accumulation operation on to-be-processed single-precision floating-point numbers to obtain a corresponding single-precision multiplication-accumulation result, and a total of N single-precision multiplication-accumulation results are obtained.

The to-be-processed single-precision floating-point numbers include two single-precision multipliers and one single-precision addend. For ease of description, the two single-precision multipliers are called a first single-precision multiplier and a second single-precision multiplier respectively.

An expression of the multiplication-accumulation operations is:

dst=op0*op1+op2

where op0 denotes the first single-precision multiplier, op1 denotes the second single-precision multiplier, op2 denotes the single-precision addend, and dst denotes a multiplication-accumulation result.

It is to be noted that, different from the half-precision floating-point number multiplication-accumulation process, since the single-precision multiplier-accumulator supports the single-precision floating-point number multiplication-accumulation operations, conversion is not required when the single-precision multiplier-accumulator performs the single-precision floating-point number multiplication-accumulation operations.

Optionally, the single-precision multiplier-accumulator may determine op01.mant according to op1.mant and op2.mant; determine op01.exp according to op0.exp and op1.exp; determine op01.S according to op0.S and op1.S; determine dst.mant, dst.exp, and dst.S according to op01.mant, op01.exp, op01.S, op2.mant, op2.exp, and op2.S; and then normalize dst.mant, dst.exp, and dst.S to a data format of the single-precision floating-point number, so as to obtain the single-precision multiplication-accumulation result.

Similarly, two operands of the addition are op01 and op2. In order to make exponents of these two numbers the same, decimals are required to be shifted. The single-precision multiplier-accumulator may determine an absolute value of an exponent difference according to op01.exp and op2.exp; perform a shift operation on op01.mant or op2.mant according to op01.exp, op2.exp, and the absolute value of the exponent difference, to obtain op01.mant after the shift operation and op2.mant after the shift operation; determine dst.mant and dst.S according to op01.S, op2.S, op01.mant after the shift operation, and op2.mant after the shift operation; and determine dst.exp according to op01.exp and op2.exp.

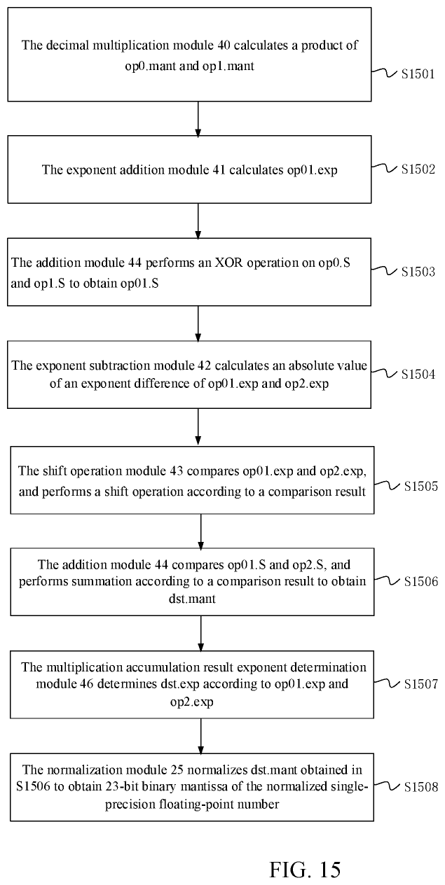

A process of the single-precision multiplier-accumulator performing the single-precision floating-point number multiplication-accumulation operations is described in detail below with reference to the structures shown in FIG. 14. As shown in FIG. 15, the process specifically includes the following steps.

In S1501, the decimal multiplication module 40 calculates a product of op0.mant and op1.mant.

Specifically, since conversion is not required when the single-precision floating-point number multiplication-accumulation operations are performed, the first conversion unit 47 and the second conversion unit 48 are in ineffective states and only perform transparent transmission functions. op1.mant and op2.mant are both 24-bit binary data, and op01.mant obtained through calculation is 48-bit binary data.

In S1502, the exponent addition module 41 calculates op01.exp.

In S1503, the addition module 44 performs an XOR operation on op0.S and op1.S to obtain op01.S.

In S1504, the exponent subtraction module 42 calculates an absolute value of an exponent difference of op01.exp and op2.exp.

In S1505, the shift operation module 43 compares op01.exp and op2.exp, and performs a shift operation according to a comparison result.

In S1506, the addition module 44 compares op01.S and op2.S, and performs summation according to a comparison result to obtain dst.mant.

In S1507, the multiplication-accumulation result exponent determination module 46 determines dst.exp according to op01.exp and op2.exp.

After dst.exp is obtained, dst.exp may be normalized to obtain an 8-bit binary exponent of the normalized single-precision floating-point number.

In S1508, the normalization module 25 normalizes dst.mant obtained in S1506 to obtain 23-bit binary mantissa of the normalized single-precision floating-point number.

Implementation processes of S1501 to S1508 are similar to those of S1302 to S1309. Details are not described herein again in the embodiments of the present disclosure. The sign bit, the 8-bit binary exponent obtained in S1507, and the 23-bit binary mantissa obtained in S1508 form the single-precision multiplication-accumulation result.

According to the multiplication-accumulation method in the embodiments of the present disclosure, when the asymmetric multiplier-accumulator performs half-precision floating-point number multiplication-accumulation operations, each single-precision multiplier-accumulator and each half-precision multiplier-accumulator both perform multiplication-accumulation operations on to-be-processed half-precision floating-point numbers to obtain corresponding half-precision multiplication-accumulation results, and a total of 2N half-precision multiplication-accumulation results are obtained. When the asymmetric multiplier-accumulator performs single-precision floating-point number multiplication-accumulation operations, each single-precision multiplier-accumulator performs the multiplication-accumulation operation on to-be-processed single-precision floating-point numbers to obtain a corresponding single-precision multiplication-accumulation result, and a total of N single-precision multiplication-accumulation results are obtained. According to the solution in the embodiments of the present disclosure, when the half-precision floating-point number multiplication-accumulation operations are performed, the single-precision multiplier-accumulators also participate in the operations and are not idle, improving utilization of the single-precision multiplier-accumulators. Moreover, compared with the design solution shown in FIG. 3, the solution in the embodiments of the present disclosure saves n half-precision multiplier-accumulators and reduces the hardware overhead.

It should be understood that, although the steps in the flowcharts involved in the embodiments as described above are displayed in sequence as indicated by the arrows, the steps are not necessarily performed in the order indicated by the arrows. Unless otherwise clearly specified herein, the steps are performed without any strict sequence limitation, and may be performed in other orders. In addition, at least some steps in the flowcharts involved in the embodiments as described above may include a plurality of steps or a plurality of stages, and such steps or stages are not necessarily performed at a same moment, and may be performed at different moments. The steps or stages are not necessarily performed in sequence, and the steps or stages and at least some of other steps or steps or stages of other steps may be performed in turn or alternately. The steps performed by the modules in the above apparatus embodiment may be obtained with reference to the description in the method embodiment.

The modules in the foregoing multiplication-accumulation apparatus may be implemented entirely or partially by software, hardware, or a combination thereof. The above modules may be built in or independent of a processor of a computer device in a hardware form, or may be stored in a memory of the computer device in a software form, so that the processor invokes and performs operations corresponding to the above modules.

In an embodiment, a computer device is further provided, including a memory and a processor. The memory stores a computer program. The processor implements the steps in the above method embodiments when executing the computer program.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

What is claimed is:

1. A multiplication-accumulation system, comprising N multiplication-accumulation units, wherein each multiplication-accumulation unit comprises a first multiplier-accumulator and a second multiplier-accumulator;
when performing a single-precision floating-point number multiplication-accumulation operation, the multiplication-accumulation unit performs a multiplication-accumulation operation on to-be-processed single-precision floating-point numbers and obtains a corresponding single-precision multiplication-accumulation result, a total of N single-precision multiplication-accumulation results being obtained; and
when performing a half-precision floating-point number multiplication-accumulation operation, the multiplication-accumulation unit performs a multiplication-accumulation operation on to-be-processed half-precision floating-point numbers and obtains corresponding half-precision multiplication-accumulation results, a total of 2N half-precision multiplication-accumulation results being obtained.

2. The multiplication-accumulation system according to claim 1, wherein the first multiplier-accumulator is a first half-precision multiplier-accumulator, the second multiplier-accumulator is a second half-precision multiplier-accumulator, and the to-be-processed single-precision floating-point numbers comprise: a first single-precision multiplier, a second single-precision multiplier, and a single-precision addend; and
when the multiplication-accumulation system performs the single-precision floating-point number multiplication-accumulation operation, the first half-precision multiplier-accumulator is configured to perform first-part multiplication to obtain a first multiplication result, and transmit the first multiplication result to the second half-precision multiplier-accumulator; the second half-precision multiplier-adder is configured to perform second-part multiplication to obtain a second multiplication result, the first-part multiplication and the second-part multiplication being classified based on a decimal of the first single-precision multiplier and a decimal of the second single-precision multiplier according to a preset rule; the second half-precision multiplier-accumulator is further configured to: determine a decimal of a multiplication result according to the first multiplication result and the second multiplication result, and determine the single-precision multiplication-accumulation result according to the decimal of the multiplication result, an exponent of the first single-precision multiplier, an exponent of the second single-precision multiplier, a sign of the first single-precision multiplier, a sign of the second single-precision multiplier, a decimal of the single-precision addend, an exponent of the single-precision addend, and a sign of the single-precision addend.

3. The multiplication-accumulation system according to claim 2, wherein the second half-precision multiplier-accumulator comprises: an exponent addition module, a decimal addition module, and a determination module;
the exponent addition module is configured to determine an exponent of the multiplication result according to the exponent of the first single-precision multiplier and the exponent of the second single-precision multiplier;
the decimal addition module is configured to determine a sign of the multiplication result according to the sign of the first single-precision multiplier and the sign of the second single-precision multiplier; and
the determination module is configured to determine a decimal of a multiplication-accumulation result, a sign of the multiplication-accumulation result, and an exponent of the multiplication-accumulation result according to the exponent of the multiplication result, the exponent of the single-precision addend, the sign of the multiplication result, the sign of the single-precision addend, the decimal of the multiplication result, and the decimal of the single-precision addend; and determine the single-precision multiplication-accumulation result according to the decimal of the multiplication-accumulation result, the sign of the multiplication-accumulation result, and the exponent of the multiplication-accumulation result.

4. The multiplication-accumulation system according to claim 3, wherein the determination module comprises: a first exponent subtraction module, a first shift operation module, a first addition module, and a first multiplication-accumulation result exponent determination module;
the first exponent subtraction module is configured to determine an absolute value of an exponent difference according to the exponent of the multiplication result and the exponent of the single-precision addend;
the first shift operation module is configured to perform a shift operation on the decimal of the multiplication result or the decimal of the single-precision addend according to the exponent of the multiplication result, the exponent of the single-precision addend, and the absolute value of the exponent difference, to obtain a decimal of a multiplication result after the shift operation and a decimal of a single-precision addend after the shift operation;
the first addition module is configured to determine the decimal of the multiplication-accumulation result and the sign of the multiplication-accumulation result according to the sign of the multiplication result, the sign of the single-precision addend, the decimal of the multiplication result after the shift operation, and the decimal of the single-precision addend after the shift operation; and
the first multiplication-accumulation result exponent determination module is configured to determine the exponent of the multiplication-accumulation result according to the exponent of the multiplication result and the exponent of the single-precision addend.

5. The multiplication-accumulation system according to claim 3, wherein the exponent addition module is configured to:
determine the exponent of the multiplication result with the following formula:
op01.exp=op0.exp+op1.exp−bias
where op01.exp denotes the exponent of the multiplication result, op0.exp denotes the exponent of the first single-precision multiplier, op1.exp denotes the exponent of the second single-precision multiplier, and bias denotes an exponent bias.

6. The multiplication-accumulation system according to claim 3, wherein the decimal addition module is configured to: perform an XOR operation on the sign of the first single-precision multiplier and the sign of the second single-precision multiplier to obtain the sign of the multiplication result.

7. The multiplication-accumulation system according to claim 4, wherein
the first shift operation module is configured to:
compare the exponent of the multiplication result with the exponent of the single-precision addend;
right-shift the decimal of the single-precision addend by a number of digits corresponding to the absolute value if the exponent of the multiplication result is greater than or equal to the exponent of the single-precision addend; and
right-shift the decimal of the multiplication result by the number of digits corresponding to the absolute value if the exponent of the multiplication result is less than the exponent of the single-precision addend;
the first addition module is specifically configured to:
invert and add one to the decimal of the single-precision addend after the shift operation if the sign of the multiplication result is different from the sign of the single-precision addend, to obtain a decimal of a single-precision addend after the inversion and addition-by-one; and sum the decimal of the multiplication result after the shift operation and the decimal of the single-precision addend after the inversion and addition-by-one, and take a sum result as the decimal of the multiplication-accumulation result; and
sum the decimal of the multiplication result after the shift operation and the decimal of the single-precision addend after the shift operation if the sign of the multiplication result is the same as the sign of the single-precision addend, and take a sum result as the decimal of the multiplication-accumulation result; and
the first multiplication-accumulation result exponent determination module is configured to:
take the exponent of the multiplication result as the exponent of the multiplication-accumulation result if the exponent of the multiplication result is greater than or equal to the exponent of the single-precision addend; and
take the exponent of the single-precision addend as the exponent of the multiplication-accumulation result if the exponent of the multiplication result is less than the exponent of the single-precision addend.

8. The multiplication-accumulation system according to claim 1, wherein the first multiplier-accumulator is a half-precision multiplier-accumulator, the second multiplier-accumulator is a single-precision multiplier-accumulator, the to-be-processed half-precision floating-point numbers comprise: a first half-precision multiplier, a second half-precision multiplier, and a half-precision addend, and the single-precision multiplier-accumulator comprises: a first conversion unit, a determination module, and a second conversion unit;
wherein the first conversion unit is configured to convert the first half-precision multiplier, the second half-precision multiplier, and the half-precision addend into single precision, to obtain a first single-precision multiplier, a second single-precision multiplier, and a single-precision addend;
the determination module is configured to determine a single-precision multiplication-accumulation result according to a decimal of the first single-precision multiplier, an exponent of the first single-precision multiplier, a sign of the first single-precision multiplier, a decimal of the second single-precision multiplier, an exponent of the second single-precision multiplier, a sign of the second single-precision multiplier, a decimal of the single-precision addend, an exponent of the single-precision addend, and a sign of the single-precision addend; and
the second conversion unit is configured to convert the single-precision multiplication-accumulation result to obtain the half-precision multiplication-accumulation result.

9. The multiplication-accumulation system according to claim 8, wherein the determination module comprises: a decimal multiplication module, an exponent addition module, an addition module, and a determination unit;
the decimal multiplication module is configured to determine a decimal of a multiplication result according to the decimal of the first single-precision multiplier and the decimal of the second single-precision multiplier;
the exponent addition module is configured to determine an exponent of the multiplication result according to the exponent of the first single-precision multiplier and the exponent of the second single-precision multiplier;
the addition module is configured to determine a sign of the multiplication result according to the sign of the first single-precision multiplier and the sign of the second single-precision multiplier; and
the determination unit is configured to determine a decimal of a multiplication-accumulation result, a sign of the multiplication-accumulation result, and an exponent of the multiplication-accumulation result according to the decimal of the multiplication result, the exponent of the multiplication result, the sign of the multiplication result, the exponent of the single-precision addend, the sign of the single-precision addend, and the decimal of the single-precision addend; and determine the single-precision multiplication-accumulation result according to the decimal of the multiplication-accumulation result, the sign of the multiplication-accumulation result, and the exponent of the multiplication-accumulation result.

10. The multiplication-accumulation system according to claim 9, wherein the determination unit comprises: a first exponent subtraction module, a first shift operation module, a first addition module, and a first multiplication-accumulation result exponent determination module;
the first exponent subtraction module is configured to determine an exponent difference according to the exponent of the multiplication result and the exponent of the single-precision addend;
the first shift operation module is configured to perform a shift operation on the decimal of the multiplication result or the decimal of the single-precision addend according to the exponent of the multiplication result, the exponent of the single-precision addend, and the exponent difference, to obtain a decimal of a multiplication result after the shift operation and a decimal of a single-precision addend after the shift operation;
the first addition module is configured to determine the decimal of the multiplication-accumulation result and the sign of the multiplication-accumulation result according to the sign of the multiplication result, the sign of the single-precision addend, the decimal of the multiplication result after the shift operation, and the decimal of the single-precision addend after the shift operation; and
the first multiplication-accumulation result exponent determination module is configured to determine the exponent of the multiplication-accumulation result according to the exponent of the multiplication result and the exponent of the single-precision addend.

11. The multiplication-accumulation system according to claim 9, wherein the exponent addition module is configured to:
determine the exponent of the multiplication result with the following formula:
op01.exp=op0.exp+op1.exp−bias
where op01.exp denotes the exponent of the multiplication result, op0.exp denotes the exponent of the first single-precision multiplier, op1.exp denotes the exponent of the second single-precision multiplier, and bias denotes an exponent bias.

12. The multiplication-accumulation system according to claim 9, wherein the addition module is configured to:
perform an XOR operation on the sign of the first single-precision multiplier and the sign of the second single-precision multiplier to obtain the sign of the multiplication result.

13. The multiplication-accumulation system according to claim 10, wherein the first shift operation module is configured to:
compare the exponent of the multiplication result with the exponent of the single-precision addend;
right-shift the decimal of the single-precision addend by a number of digits corresponding to the exponent difference if the exponent of the multiplication result is greater than or equal to the exponent of the single-precision addend; and
right-shift the decimal of the multiplication result by the number of digits corresponding to the exponent difference if the exponent of the multiplication result is less than the exponent of the single-precision addend;
the first addition module is configured to:
invert and add one to the decimal of the single-precision addend after the shift operation if the sign of the multiplication result is different from the sign of the single-precision addend, to obtain a decimal of a single-precision addend after the inversion and addition-by-one; and sum the decimal of the multiplication result after the shift operation and the decimal of the single-precision addend after the inversion and addition-by-one, and take a sum result as the decimal of the multiplication-accumulation result; and
sum the decimal of the multiplication result after the shift operation and the decimal of the single-precision addend after the shift operation if the sign of the multiplication result is the same as the sign of the single-precision addend, and take a sum result as the decimal of the multiplication-accumulation result; and
the first multiplication-accumulation result exponent determination module is configured to:
take the exponent of the multiplication result as the exponent of the multiplication-accumulation result if the exponent of the multiplication result is greater than or equal to the exponent of the single-precision addend; and
take the exponent of the single-precision addend as the exponent of the multiplication-accumulation result if the exponent of the multiplication result is less than the exponent of the single-precision addend.

14. A multiplication-accumulation method, applied to the multiplication-accumulation system according to claim 1, comprising:
obtaining, by the multiplication-accumulation system, corresponding single-precision multiplication-accumulation results when performing a single-precision floating-point number multiplication-accumulation operation, a total of N multiplication-accumulation results being obtained; and
obtaining, by the multiplication-accumulation system, corresponding half-precision multiplication-accumulation results when performing a half-precision floating-point number multiplication-accumulation operation, a total of 2N multiplication-accumulation results being obtained.

15. The multiplication-accumulation method according to claim 14, wherein the multiplication-accumulation system comprises a first half-precision multiplier-accumulator and a second half-precision multiplier-accumulator, and the to-be-processed single-precision floating-point numbers comprise: a first single-precision multiplier, a second single-precision multiplier, and a single-precision addend;
wherein the two half-precision multiplier-accumulators are combined to perform a multiplication-accumulation operation on the to-be-processed single-precision floating-point numbers to obtain the corresponding single-precision multiplication-accumulation results, comprising:
performing, by the first half-precision multiplier-accumulator, first-part multiplication to obtain a first multiplication result, and transmitting the first multiplication result to the second half-precision multiplier-accumulator;
performing, by the second half-precision multiplier-accumulator, second-part multiplication to obtain a second multiplication result, the first-part multiplication and the second-part multiplication being classified based on a decimal of the first single-precision multiplier and a decimal of the second single-precision multiplier according to a preset rule;
determining, by the second half-precision multiplier-accumulator, a decimal of a multiplication result according to the first multiplication result and the second multiplication result; and
determining, by the second half-precision multiplier-accumulator, the single-precision multiplication-accumulation result according to the decimal of the multiplication result, an exponent of the first single-precision multiplier, an exponent of the second single-precision multiplier, a sign of the first single-precision multiplier, a sign of the second single-precision multiplier, a decimal of the single-precision addend, an exponent of the single-precision addend, and a sign of the single-precision addend.

16. The multiplication-accumulation method according to claim 15, wherein the determining, by the second half-precision multiplier-accumulator, the single-precision multiplication-accumulation result according to the decimal of the multiplication result, the exponent of the first single-precision multiplier, the exponent of the second single-precision multiplier, the sign of the first single-precision multiplier, the sign of the second single-precision multiplier, the decimal of the single-precision addend, the exponent of the single-precision addend, and the sign of the single-precision addend comprises:
determining, by the second half-precision multiplier-accumulator, an exponent of the multiplication result according to the exponent of the first single-precision multiplier and the exponent of the second single-precision multiplier;
determining, by the second half-precision multiplier-accumulator, a sign of the multiplication result according to the sign of the first single-precision multiplier and the sign of the second single-precision multiplier;
determining, by the second half-precision multiplier-accumulator, a decimal of a multiplication-accumulation result, a sign of the multiplication-accumulation result, and an exponent of the multiplication-accumulation result according to the exponent of the multiplication result, the exponent of the single-precision addend, the sign of the multiplication result, the sign of the single-precision addend, the decimal of the multiplication result, and the decimal of the single-precision addend; and
determining, by the second half-precision multiplier-accumulator, the single-precision multiplication-accumulation result according to the decimal of the multiplication-accumulation result, the sign of the multiplication-accumulation result, and the exponent of the multiplication-accumulation result.

17. The multiplication-accumulation method according to claim 16, wherein the determining, by the second half-precision multiplier-accumulator, the decimal of the multiplication-accumulation result, the sign of the multiplication-accumulation result, and the exponent of the multiplication-accumulation result according to the exponent of the multiplication result, the exponent of the single-precision addend, the sign of the multiplication result, the sign of the single-precision addend, the decimal of the multiplication result, and the decimal of the single-precision addend comprises:
determining, by the second half-precision multiplier-accumulator, an absolute value of an exponent difference according to the exponent of the multiplication result and the exponent of the single-precision addend;
performing, by the second half-precision multiplier-accumulator, a shift operation on the decimal of the multiplication result or the decimal of the single-precision addend according to the exponent of the multiplication result, the exponent of the single-precision addend, and the absolute value of the exponent difference, to obtain a decimal of a multiplication result after the shift operation and a decimal of a single-precision addend after the shift operation;
determining, by the second half-precision multiplier-accumulator, the decimal of the multiplication-accumulation result and the sign of the multiplication-accumulation result according to the sign of the multiplication result, the sign of the single-precision addend, the decimal of the multiplication result after the shift operation, and the decimal of the single-precision addend after the shift operation; and
determining, by the second half-precision multiplier-accumulator, the exponent of the multiplication-accumulation result according to the exponent of the multiplication result and the exponent of the single-precision addend.

18. The multiplication-accumulation method according to claim 14, wherein the multiplication-accumulation system comprises a half-precision multiplier-adder and a single-precision multiplier-adder, and the to-be-processed half-precision floating-point numbers comprise: a first half-precision multiplier, a second half-precision multiplier, and a half-precision addend;
wherein the single-precision multiplier-accumulator performs a multiplication-accumulation operation on the to-be-processed half-precision floating-point numbers to obtain the corresponding half-precision multiplication-accumulation results, comprising:
converting, by the single-precision multiplier-accumulator, the first half-precision multiplier, the second half-precision multiplier, and the half-precision addend into single precision, to obtain a first single-precision multiplier, a second single-precision multiplier, and a single-precision addend;
determining, by the single-precision multiplier-accumulator, a single-precision multiplication-accumulation result according to a decimal of the first single-precision multiplier, an exponent of the first single-precision multiplier, a sign of the first single-precision multiplier, a decimal of the second single-precision multiplier, an exponent of the second single-precision multiplier, a sign of the second single-precision multiplier, a decimal of the single-precision addend, an exponent of the single-precision addend, and a sign of the single-precision addend; and
converting, by the single-precision multiplier-accumulator, the single-precision multiplication-accumulation result to obtain the half-precision multiplication-accumulation result.

19. The multiplication-accumulation method according to claim 18, wherein the determining, by the single-precision multiplier-accumulator, the single-precision multiplication-accumulation result according to the decimal of the first single-precision multiplier, the exponent of the first single-precision multiplier, the sign of the first single-precision multiplier, the decimal of the second single-precision multiplier, the exponent of the second single-precision multiplier, the sign of the second single-precision multiplier, the decimal of the single-precision addend, the exponent of the single-precision addend, and the sign of the single-precision addend comprises:
determining, by the single-precision multiplier-accumulator, a decimal of a multiplication result according to the decimal of the first single-precision multiplier and the decimal of the second single-precision multiplier;
determining, by the single-precision multiplier-accumulator, an exponent of the multiplication result according to the exponent of the first single-precision multiplier and the exponent of the second single-precision multiplier;
determining, by the single-precision multiplier-accumulator, a sign of the multiplication result according to the sign of the first single-precision multiplier and the sign of the second single-precision multiplier;
determining, by the single-precision multiplier-accumulator, a decimal of a multiplication-accumulation result, a sign of the multiplication-accumulation result, and an exponent of the multiplication-accumulation result according to the decimal of the multiplication result, the exponent of the multiplication result, the sign of the multiplication result, the exponent of the single-precision addend, the sign of the single-precision addend, and the decimal of the single-precision addend; and
determining, by the single-precision multiplier-accumulator, the single-precision multiplication-accumulation result according to the decimal of the multiplication-accumulation result, the sign of the multiplication-accumulation result, and the exponent of the multiplication-accumulation result.

20. The multiplication-accumulation method according to claim 19, wherein the determining, by the single-precision multiplier-accumulator, the decimal of the multiplication-accumulation result, the sign of the multiplication-accumulation result, and the exponent of the multiplication-accumulation result according to the decimal of the multiplication result, the exponent of the multiplication result, the sign of the multiplication result, the exponent of the single-precision addend, the sign of the single-precision addend, and the decimal of the single-precision addend comprises:
determining, by the single-precision multiplier-accumulator, an exponent difference according to the exponent of the multiplication result and the exponent of the single-precision addend;
performing, by the single-precision multiplier-accumulator, a shift operation on the decimal of the multiplication result or the decimal of the single-precision addend according to the exponent of the multiplication result, the exponent of the single-precision addend, and the exponent difference, to obtain a decimal of a multiplication result after the shift operation and a decimal of a single-precision addend after the shift operation;
determining, by the single-precision multiplier-accumulator, the decimal of the multiplication-accumulation result and the sign of the multiplication-accumulation result according to the sign of the multiplication result, the sign of the single-precision addend, the decimal of the multiplication result after the shift operation, and the decimal of the single-precision addend after the shift operation; and
determining, by the single-precision multiplier-accumulator, the exponent of the multiplication-accumulation result according to the exponent of the multiplication result and the exponent of the single-precision addend.
